(19) United States
(12) Patent Application Publication
(10) Pub. No.: US 2007/0288363 A1
(43) Pub. Date: Dec. 13, 2007

(54) System and method for facilitating automobile purchase payments

(75) Inventors: Eric Gerard, Largo, FL (US); Joseph Spadaro, Greenville, NC (US); Sean Marra, St. Petersburg, FL (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Mac Baren Financial LLC

(21) Appl. No.: 11/505,052

(22) Filed: Aug. 15, 2006

Related U.S. Application Data
(60) Provisional application No. 60/802,940, filed on May 23, 2006.

(51) Int. Cl. G06Q 40/00

(52) U.S. Cl. 705/39

(57) ABSTRACT

A system and method of facilitating the sale of an item is disclosed. A master account that is accessible to a vendor of the item is established. The master account is established upon receiving a request to open the master account from the vendor of the item. A customer account that is accessible to a customer who purchases the item can also be established. The customer account can be established upon receiving a request to open the customer account from the vendor of the item. Funds from a purchase rebate on the sale of the item are received and are deposited into the master account. A portion of the funds is periodically transferred to the customer account.

### CROSS-REFERENCE To RELATED APPLICATION

Under Title 35, United States Code. § 119(e) of any U.S. Provisional Application No. 60/802,940, filed May 23, 2006, entitled “System And Method For Facilitating Automobile Purchase Payments”, which is incorporated herein, by reference.

### BACKGROUND

1. Field

This disclosure relates to business methods for financing purchases. In particular, it relates with business methods of facilitating periodic payments.

2. General Background

There is great consumer demand for purchasing high-cost items, such as automobiles, household appliances and the like. Unfortunately, many people cannot afford to purchase an automobile or may fall just shy of being able to make monthly payments. In some cases, automobile dealer rebates may help a customer make a purchase, but oftentimes such rebates only help the customer initially, and the customer still has trouble making monthly payments. In many cases, customers may decide not to purchase an automobile, or other large-ticket item, even when the customer can actually afford the purchase, simply because the monthly payment schedule appears large and intimidating.

### SUMMARY

In one aspect, there is a method of facilitating the sale of an item. A master account that is accessible to a vendor of the item is established. The master account is established upon receiving a request to open the master account from the vendor of the item. A customer account that is accessible to a customer who purchases the item can also be established. The customer account can be established upon receiving a request to open the customer account from the vendor of the item. Funds from a purchase rebate on the sale of the item are received and are deposited into the master account. A portion of the funds is periodically transferred to the customer account. The vendor can be an automobile dealership, and the item can be an automobile.

In a further aspect, the customer is permitted to withdraw the portion of the funds transferred to the customer account. A debit card can be issued to the customer to allow the customer to access the funds in the customer account. The customer can also be allowed to access the full amount of any remaining portion of the funds transferred to the master account after the sale of the item. In addition, the periodically transferred portion of the funds can be applied to monthly payments by the customer for the item. The portion of the funds can be periodically transferred to the customer account in monthly installments according to a pre-established schedule.

In further aspect of the method, the master account can be established so that the master account is accessible to a plurality of vendors.

In a further aspect of the method, a purchase rebate is an incentive amount of funds advertised to be provided to the customer. Alternatively, the purchase rebate is derived from a trade-in item that the customer provides to the vendor.

In another of the method, establishing the master account comprises receiving a request at an enrollment module. In addition, establishing the customer account comprises receiving a request at an enrollment module.

In one aspect, there is a system of facilitating the sale of an item, comprising an enrollment module, a customer funding module and a customer account manager. The enrollment module receives from a vendor of the item a request to open a master account. The master account can be established to be accessible by the vendor of the item. The enrollment module can further receive from the vendor of the item a request to open a customer account. The customer account can be established to be accessible by a customer who purchases the item. The customer funding module receives funds from a purchase rebate on the sale of the item. The funds can be deposited into the master account. The customer account manager periodically transfers a portion of the funds to the customer account.

In another aspect, there is a method for financing an automobile purchase. A request is submitted to a financial institution to establish a master account with the financial institution. An enrollment request can also be submitted to the financial institution to establish an automobile purchaser account with the financial institution. The automobile purchaser account can be accessible to an automobile purchaser. The automobile can be sold to the automobile purchaser. Funds derived from an automobile purchase rebate are transferred into the master account. The financial institution is instructed to periodically make installment payments from the master account to the automobile purchaser account.

### DRAWINGS

By way of example, reference can now be made to the accompanying drawings.

FIG. 1 illustrates a data processing system that assists in the financing of a purchase.

FIGS. 2A-2B illustrate a financial model of account distribution and cash flow.

FIG. 3 illustrates a component diagram of a data processing system for assists in the financing of a purchase.

FIG. 4 illustrates a flow chart diagram for an exemplary process for financing the purchase of a vehicle.

FIGS. 5A-5C illustrate screen shots of a user interface for enrolling a customer in a payment program.

### DETAILED DESCRIPTION

Methods and systems for facilitating monthly payments of a large purchase, such as an automobile purchase, are described herein. Automobile dealerships, electronic equipment vendors, household appliance vendors, etc., can benefit from being able to sell the item at the tag price, while the customer can make lower monthly or periodic payments. The system and method describe herein utilizes trade-in funds, rebates, or any other funds that the purchaser would receive when buying an item. The customer can opt to have the rebate or any other monies to be received at the time of purchase, to be deposited into an account that periodically disburses a payment to the customer. The payment disburse to the customer can be utilized by the customer to supplement the monthly payment obligation.

Thus, the vendor can deposit a lump sum in a personal, FDIC-insured bank customer account, which can be automatically paid back in equal monthly installments over the period of time that the vendor, or the vendor and the customer determine. These monthly allocations can allow customers to effectively reduce the funds they need to make their monthly payments.

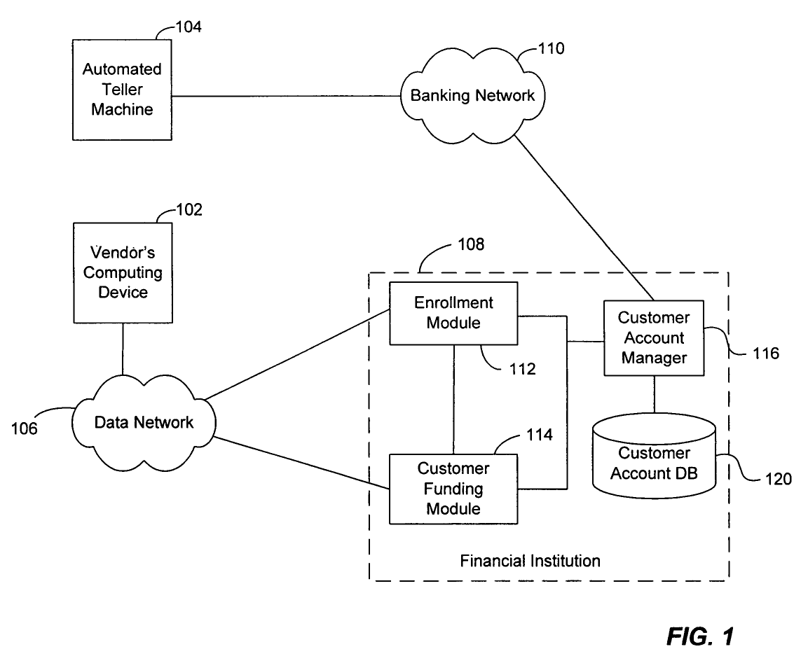

FIG. 1 illustrates a data processing system that assists in the financing of a purchase. A vendor can utilize the system provided herein to enroll in a payment program a customer who wishes to transact a purchase of a vehicle or a large-ticket item. In one embodiment, the vendor can utilize the vendor's computing device 102 to communicate with the financial institution 108. As such, through the vendor's computing device 102, the vendor can submit and instructions and commands which are communicated through a data network 106 to an enrollment module 112 and to a customer funding module 114.

In one example, the data network 106 can be the Internet. In another example, the data network 106 can be an intranet. In yet another example, the data network 106 can be a banking network.

In one example, the vendor can utilize a pre-established master account that has been established with the financial institution 108 to enroll a customer. The request to enroll a customer can be processed at the enrollment module 112. Once the customer has been enrolled, a customer's account is created and recorded in the customer account database 120. A customer account manager 116 can further be utilized to access and retrieve from the customer account database 120.

In addition, the vendor can further utilize the vendor's computing device 102 to communicate with the customer funding module 114 in order to transfer funds that are to be deposited in the customer account. Again, any actions that are taken in relation to the customer account can be recorded in the customer account database 120. Therefore, a vendor's funding of customer account through the customer funding module 114 can be reflected in the customer account database 120. Furthermore, the customer account manager having access to the customer account database 120 can retrieve information, status and account balance of the customer account. Therefore, the customer can access the customer account through an automated teller machine 104. The automated teller machine 104 can communicate with the customer account manager 116 through a banking network 110. In addition, the automated teller machine 104 can be configured to request a customer identification data which are then relayed through the banking network 110 to the customer account manager 116 for authentication.

The customer account manager 116 can further be configured to receive payment configuration parameters from the vendor. Payment configuration parameter can include a pre-defined monthly payment amount, number of total payments, etc. This pre-defined configuration can also be stored in the customer account database 120. For example, the vendor can set the monthly payment to occur on the tenth day of each month for one hundred dollars. Thus, the one hundred dollars can be paid to the customer account. In one example, the customer can receive the one-hundred-dollar payment through the automated teller machine 104. The customer can utilize a debit card to withdraw the one-hundred-dollar payment from the customer account. In another example, the customer can receive the one-hundred-dollar payment through a check that the customer receives in the mail. In yet another example, the customer can receive the one-hundred-dollar payment through a deposit in a separate bank account.

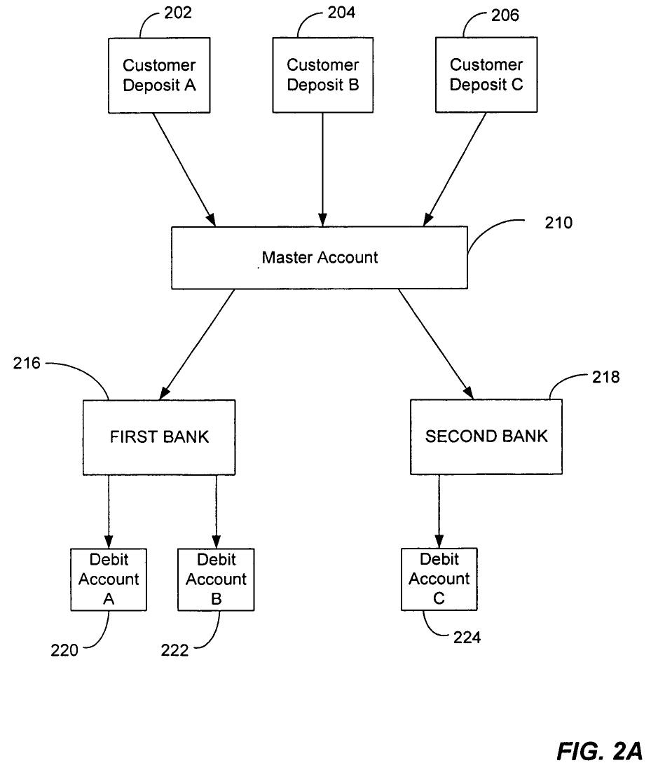

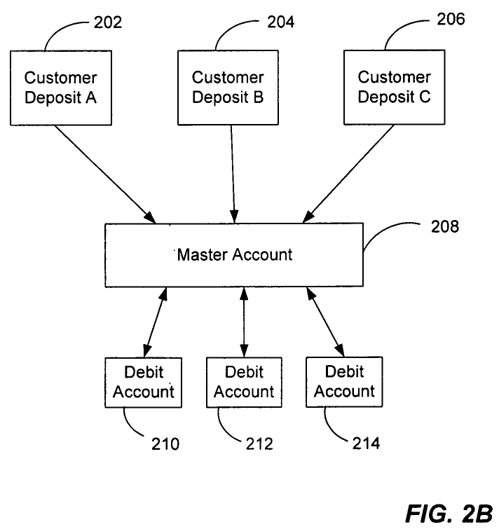

FIG. 2B illustrates a financial model of account distribution and cash flow. In one embodiment, the vendor funds a customer account by first depositing the funds into a master account 208 belonging to the vendor. For example, the vendor can place one or more deposits into the master account 208. As such, a customer deposit 202, a customer deposit 204 and a customer deposit 206 can be deposited in the master account 208 for funding of the debit customer accounts. In another embodiment, any variation of a plurality of deposits from one or more customers can be made into the master account 208.

In one embodiment, a single vendor (e.g., an automobile dealership) is the owner of the master account 208, and the master account 208 is handled by the financial institution 108. Thus, any customer deposits are transmitted to the financial institution 108 and are deposited in the master account 208. The customer account can noted to have a balance that is equal to the amount deposited in the master account 208.

In yet another embodiment, a group of vendors (e.g., dealerships) owns the master account 208. Thus, for example, a plurality of vendors or a dealership group can own the master account 208. In addition, the financial institution 108 can charge a pre-defined amount (e.g., $40 annually) for maintenance of the master account 208. The customer account manager 116 can be configured to manage the master account 208. Therefore, the customer account manager 116 can further include logic to distribute the correct payment to each debit customer account. For example, the customer account manager 116 can be configured to make a payment to a debit account 210, debit account 212, and debit account 214. The funds for each of the payments to the debit accounts 210, 212 and 214 can originate from the master account 208. The time at which the payments are made can be configured by the vendor, who at the time of enrollment in funding the customer account can establish a day of the month in which the payment should be made, as well as the specific amount of the payment.

In one embodiment, the payment can consist of transferring the payment to a separate customer debit account 210, 212 and 214. In another embodiment, the payment may consist of unlocking a certain amount from a debit account 210, 212 or 214. For example, the debit account 210 of a customer may be already vested with a funding amount of three thousand dollars. On a monthly basis, depending on the configuration of the account as dictated by the vendor, the monthly payment can be distributed and disbursed to the customer by freeing or unlocking one-hundred dollars a month out of the three-thousand dollars that are deposited on the debit account. Furthermore, upon the customer making a specific request to unlock the rest of the principal or funding of the account, the rest of the money can be available to the customer, since ultimately, the funding of the debit account comes completely from the customer's funds.

Providing a personal account for the customer permits a customer to make larger monthly payments than the customer would otherwise be able to make. For example, the vendor can be a dealer for a vehicle that the customer wants to purchase. In addition, the monthly payments called for by the finance contract are for $450. If the customer can only afford a $350 monthly payment for the new vehicle, normally the customer would not be able to afford to purchase the vehicle. However, utilizing the system and method as described in this disclosure, the customer can make a $350 payment if an additional one-hundred-dollar installment is made to the customer. Using the method disclosed herein, the customer can receive one-hundred-dollar for the monthly payment from a rebate that the customer receives for the purchase of a vehicle. In another embodiment, the customer can receive three-thousand dollars from the buy-back of a pre-owned vehicle. Thus, with a rebate, the vendor can deposit and fund the master account with three thousand dollars and establish a payment plan that would disburse one-hundred-dollar per month on a specific day of the month. In addition, the payment plan can be set to be independent of the purchaser's finance contract, and as such, the payment program would be independent of any financial obligation that the purchaser would have with a lender for the principal of a loan to finance the purchase of the vehicle.

Therefore, the purchaser of the vehicle is still contractually obligated to make the payments to the lending financial institution, and the customer, not the vendor, is responsible for making the monthly payments regardless of authorization or payment from the debit account to the purchaser. In addition, the debit account 210, 212 and 214 is configured to not provide any interest to the customer such that the initial principal that is deposited into the master account is disbursed to the debit account without any additional gain.

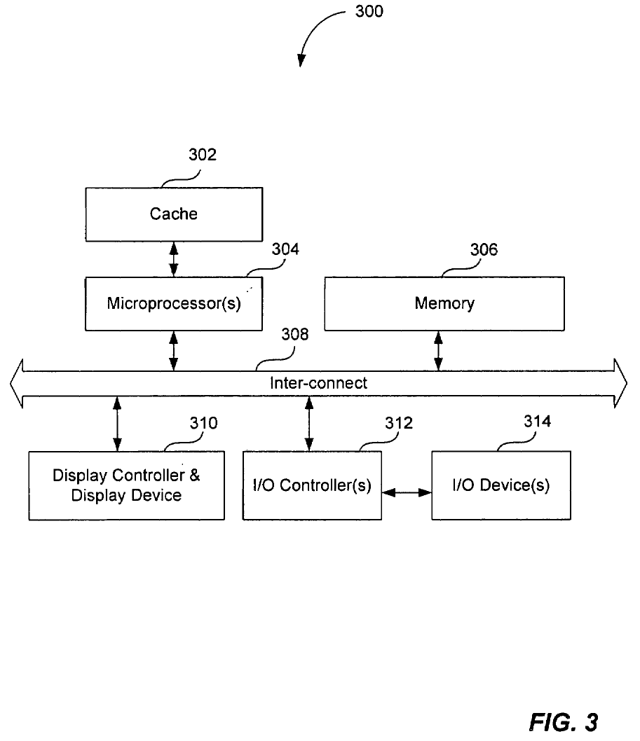

FIG. 3 illustrates a component diagram of a data processing system 300 for assists in the financing of a purchase: The system 300 includes an inter-connect 308 (e.g., bus and system core logic), which interconnects a microprocessor(s) 304 and memory 306. The microprocessor 304 is coupled to cache memory 302, which may be implemented on a same chip as the microprocessor 304).

The inter-connect 308 interconnects the microprocessor(s) 304 and the memory 306 together. Furthermore, the interconnect 308 interconnects the microprocessor 304 and the memory 306 interconnects them to a display controller and display device 310 and to peripheral devices such as input/output (I/O) devices 314 through an input/output controller(s) 317. Typical I/O devices include mice, keyboards, modems, network interfaces, printers, scanners, video cameras and other devices.

Furthermore, the interconnect 308 may include one or more buses connected to one another through various bridges, controllers and/or adapters. In one embodiment the I/O controller 312 includes a USB (Universal Serial Bus) adapter for controlling USB peripherals, and/or an IEEE-1394 bus adapter for controlling IEEE-1394 peripherals. The inter-connect 308 can also include a network connection.

The memory 306 may include ROM (Read Only Memory), and volatile RAM (Random Access Memory) and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 306 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a filter structure may be stored in memory 306 or obtained through an I/O device 314.

In general, routines executed to implement the embodiments of the invention may be implemented as part of an operating system or a specific application, component, program, object, module or sequence of instructions referred to as “computer programs.” The computer programs typically comprise one or more instructions set at various times stored in various computer readable storage media in a computer, and that, when read and executed by one or more processors in a computer, cause the computer to perform operations necessary to execute elements involving the various aspects of the invention.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

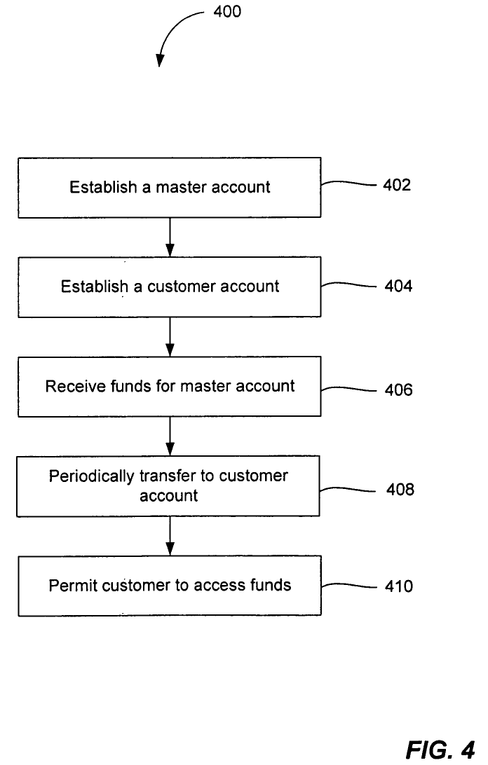

FIG. 4 illustrates a flow chart diagram for an exemplary process 400 for financing the purchase of a vehicle. The process 400 can be utilized for financing a purchase, such as an automobile purchase, according to one embodiment of the present invention.

At process block 402, a master account is established. In one embodiment, a vendor such as an automobile dealership establishes a master account with financial institution 108. The financial institution can be a bank or other lending institution. In one example, a given dealership may either establish a master account individually. In another example, a group of dealerships may establish a group account that all the dealerships in the group may use. The account may be set up by depositing an amount of money via wire transfer, ACH transfer [Question for inventors: What is an ACH transfer?], or any other suitable means with the financial institution. In some embodiments, the financial institution may charge the dealership or group of dealerships a monthly or yearly fee for maintaining the master account. The dealership can typically have access to account information and account funds in whatever manner established by the dealership and the financial institution 108 when the master account is established. The process continues to process block 404.

At process block 404, a customer account is established. At the request of the vendor, the financial institution 108 enrolls the customer in a financing program and an account for the customer is established. In one embodiment, to enroll, the vendor provides information requested by the vendor (e.g., the automobile dealership), including the amount the customer can deposit in his or her account, how much money can be transferred to the customer's debit card every month, and for how many months such transfers to the debit card can be made. Such information may be provided, for example, by the customer completing an enrollment form which is then relayed to the vendor. The dealership may also provide information to the customer during enrollment. Such information can include information regarding the financial institution holding the master account, an example of how the financing program can reduce the customer's monthly car payments, that all the money in the customer's account is the customer's money and available at any time, that the financing program is separate from the customer's finance contract for the purchase of the car, among others. The vendor may also require the customer to complete an authorization form that authorizes the vendor to transfer funds paid by the customer to the financial institution holding the master account. In another embodiment, the authorization form may also provide additional information to the customer, such as the monthly transfer amount, the financial institution's regular fee schedule, that the customer gets two free transactions per month on his/her account, among others. The process 400 continues to process bock 406.

At process bock 406, the funds are received from vendor (e.g., the automobile dealership) and deposited in the master account. The vendor executes the transfer by any means, such as wire transfer or ACH transfer. The amount of the transfer can typically have been determined during the enrollment process by the customer. In some embodiments, for example, a customer may choose to fund his account using an automobile dealer rebate on the purchase of a car. In alternative embodiments, a customer may choose to fund her account with her own money, not provided by a rebate. In some embodiments, both rebate money and other funds may be used.

Optionally, once a customer is enrolled in the financing program and the funds are transferred, the financing institution may process the customer's account and send the customer an automated teller machine debit card and additional information, such as a welcome package, an activation sticker, quick start information, terms and conditions, a fee schedule, and/or the like. Processing the customer's account includes, for example, setting up a bank account for the customer, to which monthly transfers from the master account are made and which is accessible by the customer using the debit card. In some embodiments, once the customer is enrolled, the dealership no longer has any responsibilities, duties or control of or relating to the customer's account with the financial institution. The customer may be allowed complete access to his/her funds deposited with the financial institution at any time. The process 400 continues to process bock 408.

At process bock 408, the financial institution 108 can make periodic transfers of a portion of the funds to the customer account. The transfers may be made on any designated day of the month. In another embodiment, the financial institution 108 can make monthly transfers to the debit account of the customer. The process continues to process block 410.

At process block 410, the customer may then access and use the transferred funds however she chooses, such as a debit card. For example, the customer may withdraw the funds, use the funds to make (or reduce) a monthly car payment, or the like. The bank into which the funds are transferred may allow the customer to have any desired number of transactions with the ATM debit card per month, such as two transactions, unlimited transactions, etc. If at any time the customer wishes to withdraw more than the amount monthly transferred to the bank account, the customer may contact the financial institution holding the master account and request additional money.

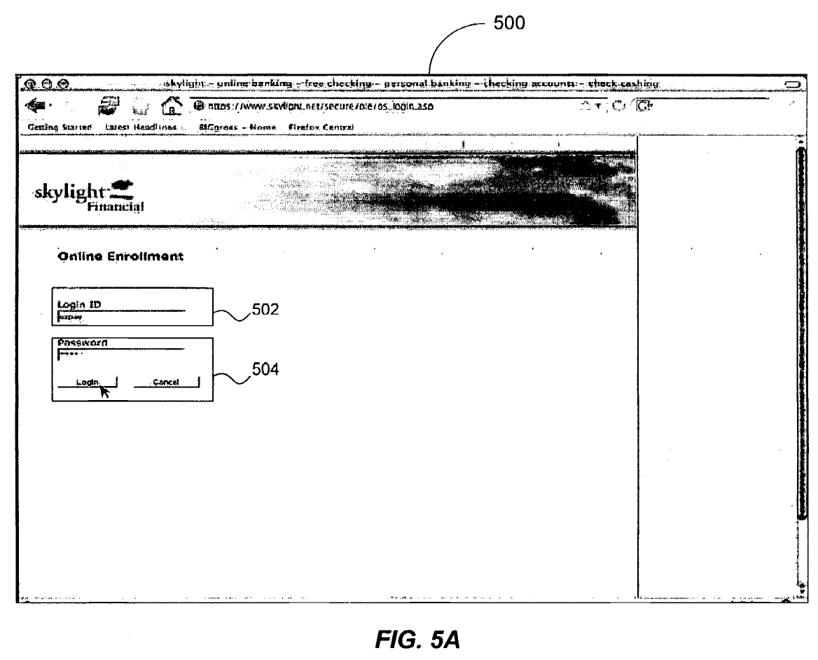

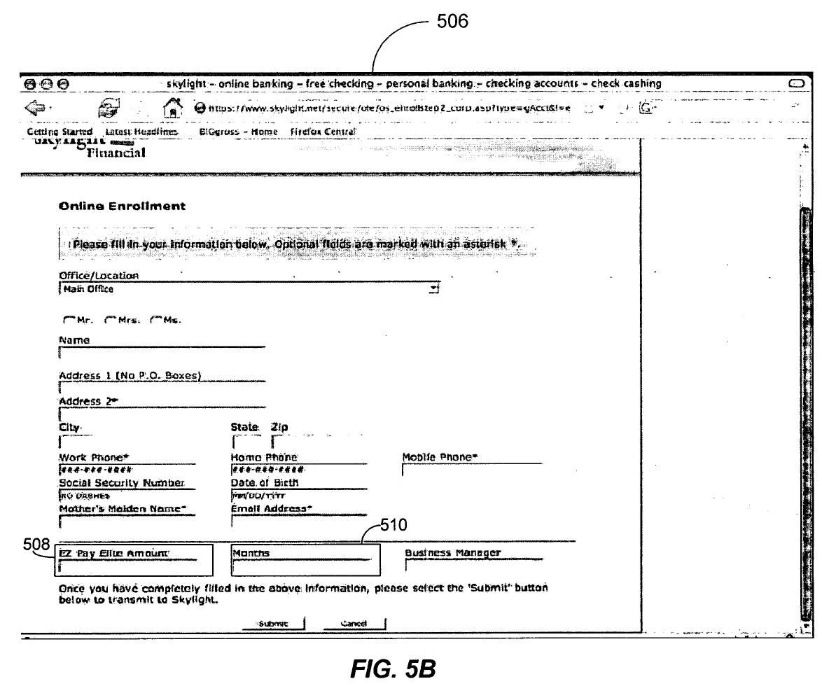

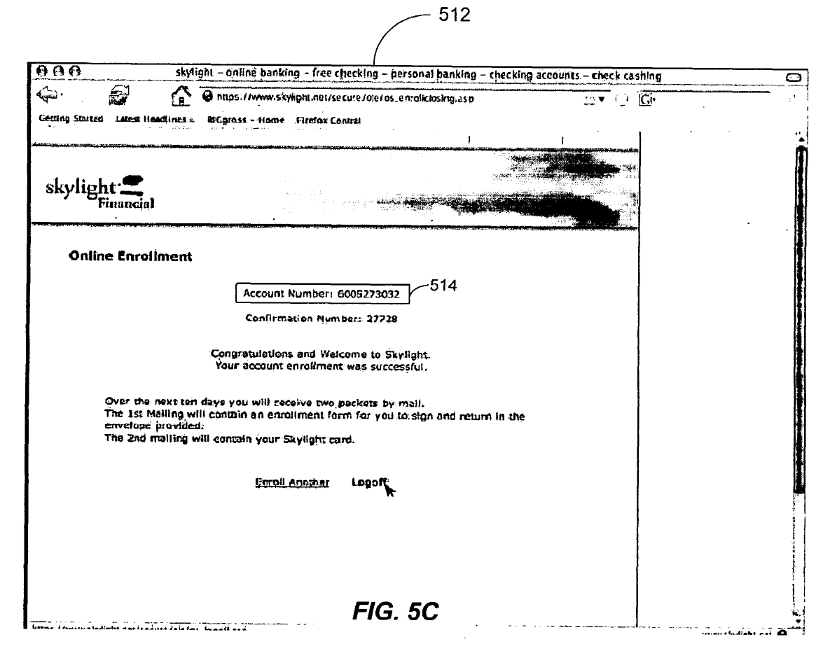

FIGS. 5A-5C illustrate screen shots of a user interface for enrolling a customer in a payment program. User interface 500 illustrates a screenshot of a web browser that provides a user interface for authenticating a user identifier 502 and a password 504. The user interface 500 can be utilized to interact with a website provided by the financial institution 108.

For example, the user identifier 502 and the password 504 can be entered by an employee of the vendor. In another embodiment where the vendor is a vehicle dealer, or for example, a automobile salesperson can access the user interface 500 to authenticate a user identifier 502 and a password 504 corresponding to the vendor. The authentication user interface 500 permits a lender or an agent of a vendor to access the master account established with the financial institution 108.

FIG. 5B illustrates a screenshot of a window for a web browser that provides a user interface for enrolling a customer of the vendor. The user interface 506 provides fields to enter data corresponding to the customer, such as name, address, city, state and ZIP code. In addition, the user interface 506 also provides a payment amount field 508 and a month field 510 which are utilized by the vendor to configure the payment plan. The payment plan can then be utilized by the financial institution 108 to disburse the monthly payment to the debit account of the customer (e.g., the purchaser of the automobile).

FIG. 5C illustrates a screenshot of a web browser providing a user interface 512 that displays an account number and a confirmation number for the enrolled customer. Once the enrollment form has been filled out at user interface 506, a confirmation number can be provided at user interface 512. In addition, a confirmation number corresponding to the account number 514 can further be provided.

The account number provided for the customer can be then utilized by the customer to withdraw funds from the customer account. In addition, the customer can further receive a debit card that is then used by the customer to withdraw money from the automated teller machine 104.

Although some of the drawings illustrate a number of operations in a particular order, operations which are not order dependent may be reordered and other operations may be combined or broken out. While some reordering or other groupings are specifically mentioned, others can be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It can be evident that various modifications may be made thereto without departing from the broader spirit and scope of the invention as set forth in the following claims. The specification and drawings are, accordingly, to be regarded in an illustrative sense rather than a restrictive sense.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method facilitating the sale of an item, comprising:
establishing a master account that is accessible to a vendor of the item, the master account being established upon receiving a request to open the master account from the vendor of the item;
establishing a customer account that is accessible to a customer who purchases the item, the customer account being established upon receiving a request to open the customer account from the vendor of the item;
receiving funds from a purchase rebate on the sale of the item, the funds being deposited into the master account; and
periodically transferring a portion of the funds to the customer account.

2. The method of claim 1, further comprising permitting the customer to withdraw the portion of the funds transferred to the customer account.

3. The method of claim 1, further comprising issuing a debit card to the customer to allow the customer to access the funds in the customer account.

4. The method of claim 1, further comprising allowing the customer to access the full amount of any remaining portion of the funds transferred to the master account after the sale of the item.

5. The method of claim 1, further comprising applying the periodically transferred portion of the funds to monthly payments by the customer for the item.

6. The method of claim 1, further comprising establishing the master account so that the master account is accessible to a plurality of vendors.

7. The method of claim 1, wherein the vendor is an automobile dealership, and the item is an automobile.

8. The method of claim 1, wherein the purchase rebate is an incentive amount of funds advertised to be provided to the customer.

9. The method of claim 1, wherein the purchase rebate is derived from a trade-in item that the customer provides to the vendor.

10. The method of claim 1, wherein establishing the master account comprises receiving a request at an enrollment module.

11. The method of claim 1, wherein establishing the customer account comprises receiving a request at an enrollment module.

12. The method of claim 1, wherein periodically transferring the portion of the funds comprises transferring monthly installments according to a pre-established schedule.

13. A system of facilitating the sale of an item, comprising:
an enrollment module that receiving from a vendor of the item a request to open a master account, the master account being established to be accessible by the vendor of the item, the enrollment module further receiving from the vendor of the item a request to open a customer account, the customer account being established to be accessible by a customer who purchases the item;
a customer funding module that receives funds from a purchase rebate on the sale of the item, the funds being deposited into the master account; and
a customer account manager that periodically transfers a portion of the funds to the customer account.

14. The system of claim 13, wherein the customer account manager is configured to permit the customer to withdraw the portion of the funds transferred to the customer account.

15. The system of claim 13, wherein the customer account manager is configured to issue a debit card to the customer to allow the customer to access the funds in the customer account.

16. The system of claim 13, wherein the customer account manager is configured to allow the customer to access the full amount of any remaining portion of the funds transferred to the master account after the sale of the item.

17. The system of claim 13, wherein the enrollment module is configured to grant access to the master account to a plurality of vendors.

18. The system of claim 13, wherein the vendor is an automobile dealership, and the item is an automobile.

19. The system of claim 13, wherein the purchase rebate is an incentive amount of funds advertised to be provided to the customer.

20. The system of claim 13, wherein the purchase rebate is derived from a trade-in item that the customer provides to the vendor.

21. The system of claim 13, wherein the customer account manager periodically transfers the portion of the funds by transferring monthly installments according to a pre-established schedule.

22. A method for financing an automobile purchase, comprising:
submitting a request to a financial institution to establish a master account with the financial institution;
submitting an enrollment request to the financial institution to establish an automobile purchaser account with the financial institution, wherein the automobile purchaser account is accessible to an automobile purchaser;
selling the automobile to the automobile purchaser; and
transferring funds derived from an automobile purchase rebate into the master account; and
instructing the financial institution to periodically make installment payments from the master account to the automobile purchaser account.

23. The method of claim 22, wherein the automobile purchaser can access the funds in the automobile purchaser account to make a payment for the purchase of the automobile.

24. The method of claim 22, wherein the purchase rebate is derived from a trade-in automobile provided by the automobile purchaser.
